(19) United States
(12) Patent Application Publication
(10) Pub. No.: US 2010/0064350 A1
(43) Pub. Date: Mar. 11, 2010

(54) Apparatus and Method for Secure Affinity Group Management

(75) Inventors: Lakshminath Reddy Dondeti, Hyderabad (IN); Vidya Narayanan, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/554,620

(22) Filed: Sep. 4, 2009

Related U.S. Application Data
(60) Provisional application No. 61/095,234, filed on Sep. 8, 2008.

(51) Int. Cl. H04L 9/32; H04L 9/08

(52) U.S. Cl. 726/4; 380/278; 726/5

(57) ABSTRACT

Disclosed is a method for security management in a station. In the method, a pre-registered credential is received. The pre-registered credential has been associated with a network group by a registration entity. The station is established as a member of the network group based on the received pre-registered credential thereby effecting access rights with other member stations participating in the network group.

### CLAIM OF PRIORITY UNDER 35 U.S.C. §119

The present Application for Patent claims priority to Provisional Application No. 61/095,234 entitled “APPARATUS AND METHOD FOR SECURE AFFINITY GROUP MANAGEMENT” filed Sep. 8, 2008, and assigned to the assignee hereof and hereby expressly incorporated by reference herein.

### BACKGROUND

1. Field

The present invention relates generally to secure affinity group management.

2. Background

The field of communications has many applications including, e.g., paging, wireless local loops, Internet telephony, and satellite communication systems. An exemplary application is a cellular telephone system for mobile subscribers. (As used herein, the term “cellular” system encompasses both cellular and personal communications services (PCS) system frequencies.) Modern communication systems, such as a wireless communication system, designed to allow multiple users to access a common communications medium have been developed for such cellular systems. These modern communication systems may be based on multiple access techniques such as code division multiple access (CDMA), time division multiple access (TDMA), frequency division multiple access (FDMA), space division multiple access (SDMA), polarization division multiple access (PDMA), or other modulation techniques known in the art. These modulation techniques demodulate signals received from multiple users of a communication system, thereby enabling an increase in the capacity of the communication system. In connection therewith, various wireless communication systems have been established including, e.g., Advanced Mobile Phone Service (AMPS), Global System for Mobile communication (GSM), and other wireless systems.

In FDMA systems, the total frequency spectrum is divided into a number of smaller sub-bands and each user is given its own sub-band to access the communication medium. Alternatively, in TDMA systems, the total frequency spectrum is divided into a number of smaller sub-bands, each sub-band is shared among a number of users, and each user is allowed to transmit in predetermined time slots using that sub-band. A CDMA system provides potential advantages over other types of systems, including increased system capacity. In CDMA systems, each user is given the entire frequency spectrum for all of the time, but distinguishes its transmission through the use of a unique code.

Affinity network groups may be formed as an overlay on an existing network. Existing secure group management may be cumbersome.

There is therefore a need in the art for less cumbersome security management for a station accessing a network group.

### SUMMARY

An aspect of the present invention may reside in a method for security management in a station. In the method, a pre-registered credential is received. The pre-registered credential has been associated with a network group by a registration entity. The station is established as a member of the network group based on the received pre-registered credential thereby effecting access rights with other member stations participating in the network group.

In more detailed aspects of the invention, the pre-registered credential may be based on a biometric of a person such as the person's fingerprint or voice signature. The person may be an organizer of the network group. The registration entity may be an enrollment server, and establishing the station as a member of the network group may comprise the enrollment server verifying that the station's received pre-registered credential is in accordance with the pre-registered credential associated with the network group. Alternatively, the registration entity may be a peer member station of the network group, and establishing the station as a member of the network group may comprise the peer member station verifying that the station's received pre-registered credential is in accordance with the pre-registered credential associated with the network group. Establishing the station as a member of the network group may further comprise the station receiving a secret key distributed only to member stations of the network group.

In other more detailed aspects of the invention, the network group may communicate using a peer-to-peer overlay network. The overlay network may be built on an IP network. The network group may be an affinity group. The access rights may be permanent, or temporary. Further, the network group may be an ad hoc network group.

In other more detailed aspects of the invention, receiving the pre-registered credential may comprise deriving the pre-registered group credential from a characteristic of an object temporarily situated in close proximity to the station. Further, the object in close proximity may be a person.

Another aspect of the invention may reside in an apparatus having security management, comprising: means for receiving a pre-registered credential, the pre-registered credential having been associated with a network group by a registration entity; and means for establishing the apparatus as a member of the network group based on the received pre-registered credential thereby effecting access rights with other member stations participating in the network group.

Yet another aspect of the invention may reside in an apparatus having security management, comprising a processor, configured to receive a pre-registered credential, the pre-registered credential having been associated with a network group by a registration entity, and to establish the apparatus as a member of the network group based on the received pre-registered credential thereby effecting access rights with other member stations participating in the network group.

Another aspect of the invention may reside in a computer program product, comprising computer-readable medium storing code for causing a computer to receive a pre-registered credential, the pre-registered credential having been associated with a network group by a registration entity, and code for causing a computer to establish the computer as a member of the network group based on the received pre-registered credential thereby effecting access rights with other member stations participating in the network group.

### BRIEF DESCRIPTION OF THE DRAWINGS

FIG. 1 is a block diagram of an example of a wireless communication system.

FIG. 2 is a flow diagram of a method for security management in a station.

FIG. 3 is a block diagram of a network group with a separate registration entity.

FIG. 4 is a block diagram of a network group with a peer registration entity.

FIG. 5 is a block diagram of a network group with a credential-related object in close proximity.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

A remote station, also known as a mobile station (MS), an access terminal (AT), user equipment or subscriber unit, may be mobile or stationary, and may communicate with one or more base stations, also known as base transceiver stations (BTSs) or node Bs. A remote station transmits and receives data packets through one or more base stations to a base station controller, also known as radio network controllers (RNCs). Base stations and base station controllers are parts of a network called an access network. An access network transports data packets between multiple remote stations. The access network may be further connected to additional networks outside the access network, such as a corporate intranet or the Internet, and may transport data packets between each remote station and such outside networks. A remote station that has established an active traffic channel connection with one or more base stations is called an active remote station, and is said to be in a traffic state. A remote station that is in the process of establishing an active traffic channel connection with one or more base stations is said to be in a connection setup state. A remote station may be any data device that communicates through a wireless channel. A remote station may further be any of a number of types of devices including but not limited to PC card, compact flash, external or internal modem, or wireless phone. The communication link through which the remote station sends signals to the base station is called an uplink, also known as a reverse link. The communication link through which a base station sends signals to a remote station is called a downlink, also known as a forward link.

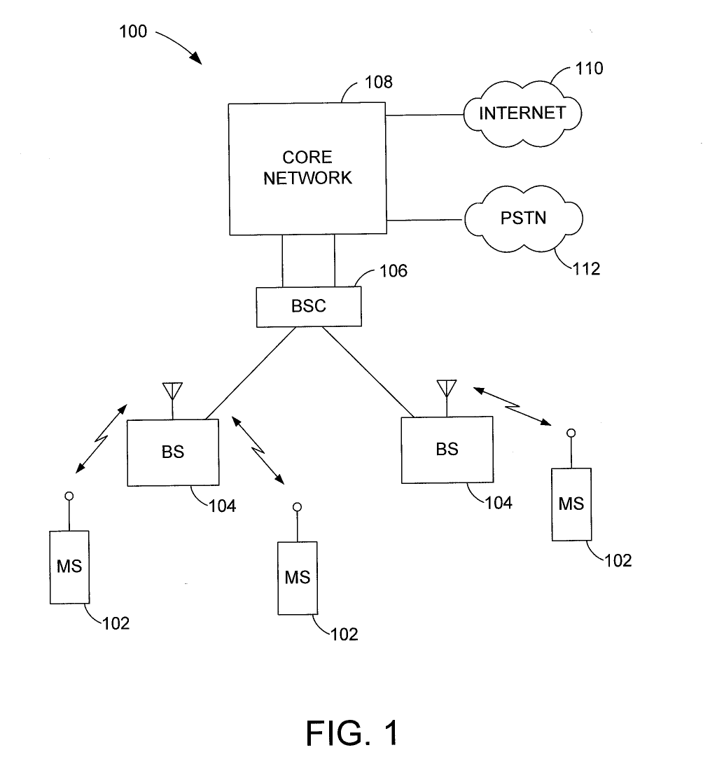

With reference to FIG. 1, a wireless communication system 100 includes one or more wireless mobile stations (MS) 102, one or more base stations (BS) 104, one or more base station controllers (BSC) 106, and a core network 108. Core network may be connected to an Internet 110 and a Public Switched Telephone Network (PSTN) 112 via suitable backhauls. A typical wireless mobile station may include a handheld phone, or a laptop computer. Wireless communication system 100 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

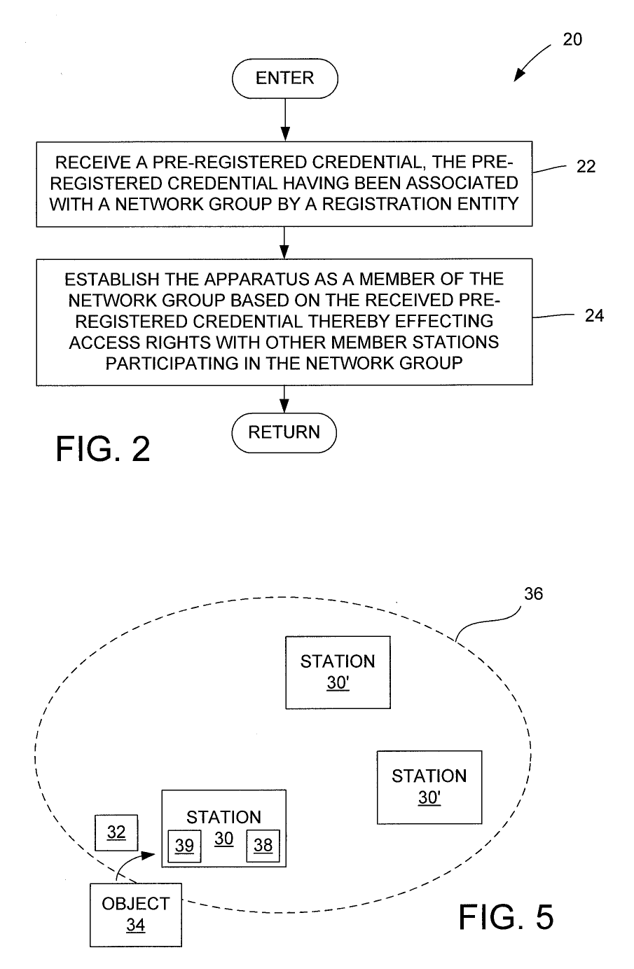

With reference to FIGS. 2-4, an aspect of the present invention may reside in a method 20 for security management in a station 30. In the method, a pre-registered credential 32 is received (step 22). The pre-registered credential has been associated with a network group 36 by a registration entity 37. The station is established as a member of the network group based on the received pre-registered credential thereby effecting access rights with other member stations participating in the network group (step 24).

The pre-registered credential 32 may be based on a biometric of a person such as the person's fingerprint or voice signature. The person may be an organizer of the network group 36.

The registration entity 37 may be an enrollment server, and establishing the station 30 as a member of the network group 36 may comprise the enrollment server verifying that the station's received credential 32 is in accordance with the pre-registered credential associated with the network group. Alternatively, the registration entity 37 may be a peer member station 30′ of the network group, and establishing the station as a member of the network group may comprise the peer member station verifying that the station's received credential is in accordance with the pre-registered credential associated with the network group. Establishing the station as a member of the network group may comprise the station receiving a secret key distributed only to member stations of the network group.

The network group 36 may communicate using a peer-to-peer overlay network. The overlay network may be built on an IP network. The network group may be an affinity group. The access rights may be permanent, or temporary. Further, the network group may be an ad hoc network group.

With reference to FIG. 5, receiving the pre-registered group credential 32 may comprise deriving the pre-registered credential from a characteristic of an object 34 temporarily situated in close proximity to the station 30. Further, the object in close proximity may be a person. The station may join or be established as a member of the network group 36 based on the received credential thereby effecting access rights.

Another aspect of the invention may reside in an apparatus 30 having security management, comprising: means 38 for receiving a pre-registered credential 32, the pre-registered credential having been associated with a network group 36 by a registration entity 37; and means 38 for establishing the apparatus as a member of the network group based on the received pre-registered credential thereby effecting access rights with other member stations 30′ participating in the network group.

Yet another aspect of the invention may reside in an apparatus 30 having security management, comprising a processor 38, configured to receive a pre-registered credential 32, the pre-registered credential having been associated with a network group 36 by a registration entity 37, and configured to establish the apparatus as a member of the network group based on the received pre-registered credential thereby effecting access rights with other member stations 30′ participating in the network group.

Another aspect of the invention may reside in a computer program product, comprising computer-readable medium 39, storing code for causing a computer 38 to receive a pre-registered credential 32, the pre-registered credential having been associated with a network group 36 by a registration entity 37, and code for causing a computer to establish the computer as a member of the network group based on the received pre-registered credential thereby effecting access rights with other member stations 30′ participating in the network group.

Affinity groups may exist within or outside the context of an overlay network. An overlay network connects a number of nodes in a topology built on an existing IP network. The affinity may be in the context of an application, or something more generic such as friends and family, etc. Nodes belonging to various affinity group members may form and overlay. Some overlays may need access control to handle affinity group membership or overlay participation itself, e.g., only allowing authorized displays to access photographs, and the like. Communication among the affinity group nodes itself may need to be secured.

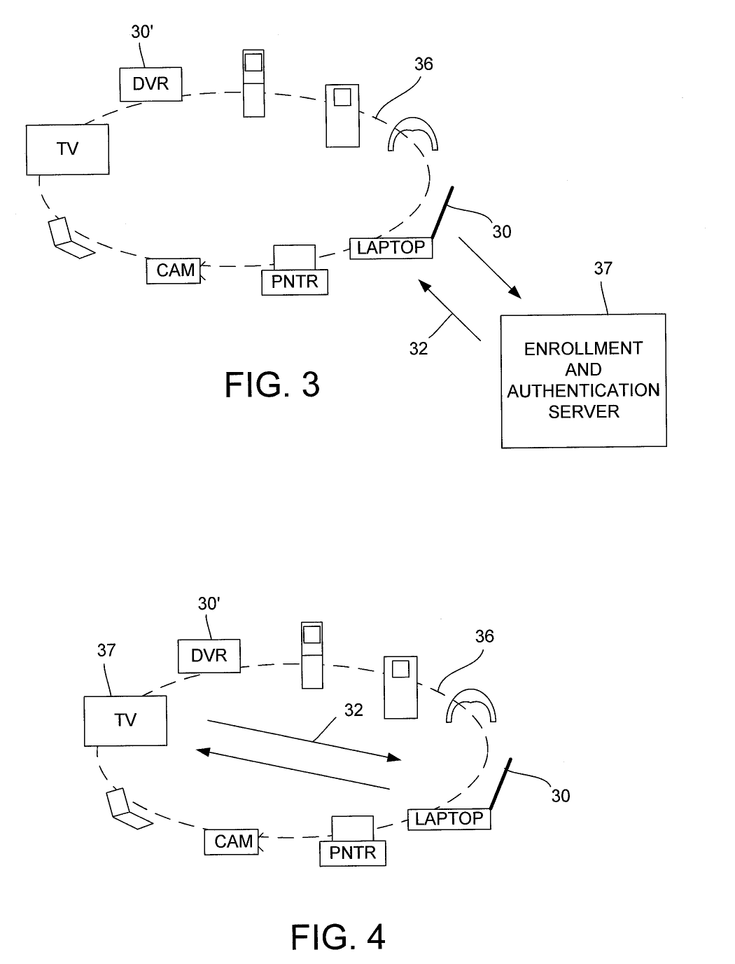

With reference again to FIG. 3, the affinity group 36 may be a home network of stations or devices, 30 and 30′, such as a TV, DVR, cell phone, handheld video/music player, game controller, laptop computer, printer, camera, handheld video game, etc. In infrastructure assisted affinity group formation, the affinity group is registered with an enrollment and authentication server 37, and a credential, e.g., based on a fingerprint, is associated with the affinity group. After the affinity group registration is complete, the credential 32 is pre-registered. In infrastructure assisted affinity group joining, a station establishes membership in the affinity group by forwarding a credential to the server, which verifies and confirms it as associated with the affinity group.

With reference again to FIG. 4, in peer-to-peer affinity group management, a designated station 37 locally associates or pre-registers a credential 32 with the affinity group. A peer station joins the group by presenting the credential.

An access control list (ACL) may be included during registration to limit access to the affinity group or overlay. Types of credentials 32 that may be used include biometric ones such as ones based on fingerprints, pre-shared secret keys (PSKs), and self-signed certificates, initially associated with an affinity group with a second factor or authentication such as the former.

A wireless device 102, or station 30, may include various components that perform functions based on signals that are transmitted by or received at the wireless device. For example, a wireless headset may include a transducer adapted to provide an audio output based on a signal received via the receiver. A wireless watch may include a user interface adapted to provide an indication based on a signal received via the receiver. A wireless sensing device may include a sensor adapted to provide data to be transmitted to another device.

A wireless device may communicate via one or more wireless communication links that are based on or otherwise support any suitable wireless communication technology. For example, in some aspects a wireless device may associate with a network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, a medical device (e.g., a biometric sensor, a heart rate monitor, a pedometer, an EKG device, etc.), a user I/O device (e.g., a watch, a remote control, a light switch, a keyboard, a mouse, etc.), a tire pressure monitor, a computer, a point-of-sale device, an entertainment device, a hearing aid, a set-top box, or any other suitable device.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, a medical device (e.g., a biometric sensor, a heart rate monitor, a pedometer, an EKG device, etc.), a user I/O device (e.g., a watch, a remote control, a light switch, a keyboard, a mouse, etc.), a tire pressure monitor, a computer, a point-of-sale device, an entertainment device, a hearing aid, a set-top box, or any other suitable device.

These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may he represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for security management in a station, comprising:
receiving a pre-registered credential, the pre-registered credential having been associated with a network group by a registration entity; and
establishing the station as a member of the network group based on the received pre-registered credential thereby effecting access rights with other member stations participating in the network group.

2. A method for security management as defined in claim 1, wherein the pre-registered credential is based on a biometric of a person.

3. A method for security management as defined in claim 2, wherein the biometric is the person's fingerprint.

4. A method for security management as defined in claim 2, wherein the biometric is a voice signature of the person.

5. A method for security management as defined in claim 2, wherein the person is an organizer of the network group.

6. A method for security management as defined in claim 1, wherein the registration entity is an enrollment server.

7. A method for security management as defined in claim 6, wherein establishing the station as a member of the network group comprises the enrollment server verifying that the station's received pre-registered credential is in accordance with the pre-registered credential associated with the network group.

8. A method for security management as defined in claim 1, wherein the registration entity is a peer member station of the network group.

9. A method for security management as defined in claim 8, wherein establishing the station as a member of the network group comprises the peer member station verifying that the station's received pre-registered credential is in accordance with the pre-registered credential associated with the network group.

10. A method for security management as defined in claim 1, wherein establishing the station as a member of the network group comprises the station receiving a secret key distributed only to member stations of the network group.

11. A method for security management as defined in claim 1, wherein the network group communicates using a peer-to-peer overlay network.

12. A method for security management as defined in claim 11, wherein the overlay network is built on an IP network.

13. A method for security management as defined in claim 1, wherein the network group is an affinity group.

14. A method for security management as defined in claim 1, wherein the access rights are permanent.

15. A method for security management as defined in claim 1, wherein the access rights are temporary.

16. A method for security management as defined in claim 1, wherein the network group is an ad hoc network group.

17. A method for security management as defined in claim 1, wherein receiving the pre-registered credential comprises deriving the pre-registered credential from a characteristic of an object temporarily situated in close proximity to the station.

18. A method for security management as defined in claim 17, wherein the object is a person.

19. An apparatus having security management, comprising:
means for receiving a pre-registered credential, the pre-registered credential having been associated with a network group by a registration entity; and
means for establishing the apparatus as a member of the network group based on the received pre-registered credential thereby effecting access rights with other member stations participating in the network group.

20. An apparatus having security management as defined in claim 19, wherein the pre-registered credential is based on a biometric of a person.

21. An apparatus having security management as defined in claim 20, wherein the biometric is the person's fingerprint.

22. An apparatus having security management as defined in claim 20, wherein the biometric is a voice signature of the person.

23. An apparatus having security management as defined in claim 20, wherein the person is an organizer of the network group.

24. An apparatus having security management as defined in claim 19, wherein the registration entity is art enrollment server.

25. An apparatus having security management as defined in claim 19, wherein the registration entity is a peer member station of the network group.

26. An apparatus having security management as defined in claim 19, wherein the means for establishing the station as a member of the network group comprises means for receiving a secret key distributed only to member stations of the network group.

27. An apparatus having security management as defined in claim 19, wherein the network group is an affinity group.

28. An apparatus having security management as defined in claim 19, wherein the access rights are permanent.

29. An apparatus having security management as defined in claim 19, wherein the access rights are temporary.

30. An apparatus having security management as defined in claim 19, wherein the network group is an ad hoc network group.

31. An apparatus having security management as defined in claim 19, wherein the means for receiving the pre-registered credential comprises means for deriving the pre-registered credential from a characteristic of an object temporarily situated in close proximity to the station.

32. An apparatus having security management as defined in claim 31, wherein the object is a person.

33. An apparatus having security management, comprising:
a processor configured to:
receive a pre-registered credential, the pre-registered credential having been associated with a network group by a registration entity; and
establish the apparatus as a member of the network group based on the received pre-registered credential thereby effecting access rights with other member stations participating in the network group.

34. An apparatus having security management as defined in claim 33, wherein the pre-registered credential is based on a biometric of a person.

35. An apparatus having security management as defined in claim 34, wherein the biometric is the person's fingerprint.

36. An apparatus having security management as defined in claim 34, wherein the biometric is a voice signature of the person.

37. An apparatus having security management as defined in claim 34, wherein the person is an organizer of the network group.

38. An apparatus having security management as defined in claim 33, wherein the processor is further configured to:
receive a secret key distributed only to member stations of the network group.

39. An apparatus having security management as defined in claim 33, wherein the network group is an affinity group.

40. An apparatus having security management as defined in claim 33, wherein the access rights are permanent.

41. An apparatus having security management as defined in claim 33, wherein the access rights are temporary.

42. An apparatus having security management as defined in claim 33, wherein the network group is an ad hoc network group.

43. An apparatus having security management as defined in claim 33, wherein the processor is further configured to:
derive the pre-registered credential from a characteristic of an object temporarily situated in close proximity to the station.

44. An apparatus having security management as defined in claim 43, wherein the object is a person.

45. A computer program product, comprising:
computer-readable medium storing:
code for causing a computer to receive a pre-registered credential, the pre-registered credential having been associated with a network group by a registration entity; and
code for causing a computer to establish the computer as a member of the network group based on the received pre-registered credential thereby effecting access rights with other member stations participating in the network group.

46. A computer program product as defined in claim 45, wherein the pre-registered credential is based on a biometric of a person.

47. A computer program product as defined in claim 46, wherein the biometric is the person's fingerprint.

48. A computer program product as defined in claim 46, wherein the biometric is a voice signature of the person.

49. A computer program product as defined in claim 46, wherein the person is an organizer of the network group.

50. A computer program product as defined in claim 45, wherein the computer-readable medium further stores:
code for causing a computer to receive a secret key distributed only to member stations of the network group.

51. A computer program product as defined in claim 44, wherein the network group is an affinity group.

52. A computer program product as defined in claim 45, wherein the access rights are permanent.

53. A computer program product as defined in claim 45, wherein the access rights are temporary.

54. A computer program product as defined in claim 45, wherein the network group is an ad hoc network group.

55. A computer program product t as defined in claim 45, wherein the computer-readable medium further stores:
code for causing a computer to derive the pre-registered credential from a characteristic of an object temporarily situated in close proximity to the station.

56. A computer program product as defined in claim 55, wherein the object is a person.
